(19) United States
(12) Patent Application Publication
(10) Pub. No.: US 2008/0291487 A1
(43) Pub. Date: Nov. 27, 2008

(54) Pre-press proofing in digital printing

(75) Inventor: Christopher A. Mazur, Henrietta, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION

(21) Appl. No.: 11/805,599

(22) Filed: May 23, 2007

(51) Int. Cl. G06F 3/12

(52) U.S. Cl. 358/1.15

(57) ABSTRACT

A method of variable data digital printing where certain record images are selected from a database and user designated variable data is entered into the selected record images creating personalized images. Data tags are inserted into the personalized images which are stored. The stored personalized images are scanned for specified tags; and, the results of the scan identified to the user for verification of accuracy. Provision is made for correction, inputs from a user interface and the corrected images rescanned; and, upon verification of accuracy, the job may be released by the user for executing the print job.

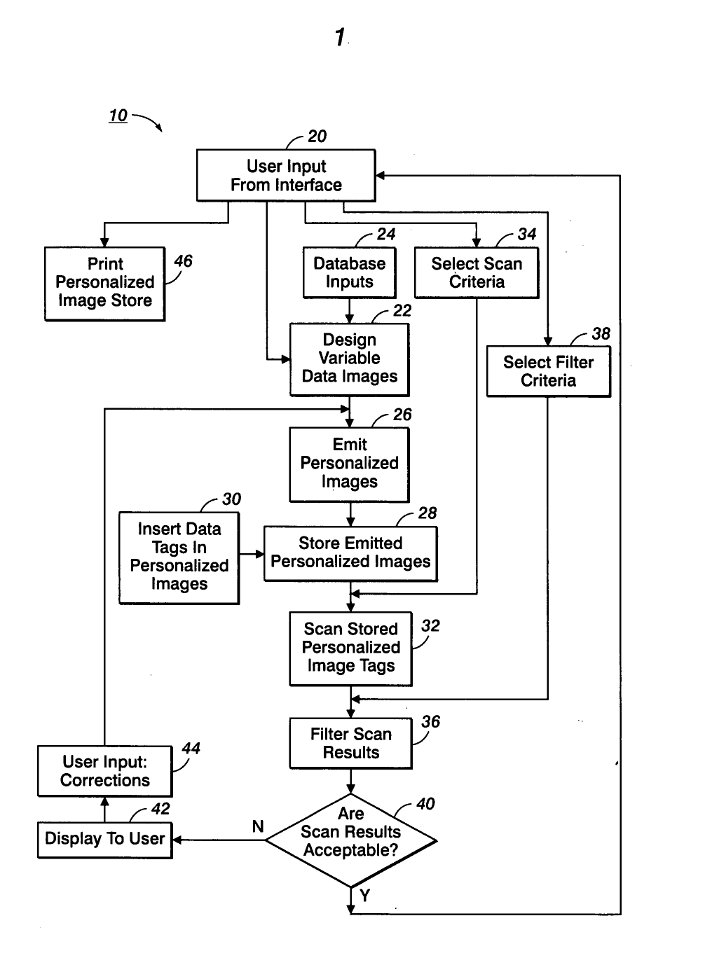

### BACKGROUND

The present disclosure relates to digital printing and particularly, to printing jobs where variable information from a database is digitally entered automatically into a template for a particularly selected print job. Variable data printing offers the advantage that a personalized or customized document can be created and printed automatically from a database of information without the need to manually perform a pre-press arrangement of the information on the page to be printed or individually on an image page.

However, where the print job requires many personalized page images to be generated from information in the database; and, where accuracy of the information extracted from the database for each personalized image is critical as, for example, where medical, financial or employee information is involved, it is necessary to proof each page for accuracy. Heretofore, there has been no way of enabling the user or person ordering the print job to verify the data entered into the personalized images prior to printing to insure that the proper information has been extracted from the database and entered correctly into the personalized images. Thus, it has been desired to provide in a digital variable data print job a way or means of automatically proof checking or verifying the particular images to be printed, prior to printing.

### BRIEF DESCRIPTION

The present disclosure describes a method or process of variable data printing from digital images which addresses the above-described problem and provides, through a user interface, for inputting the requirements for design of the variable data image and for selecting records from a database of record images according to a set of instructions. The system then automatically enters the user designated variable data into the selected record images and thus creates personalized or customized images. The personalized images are stored and data tags are entered into the information of each of the stored personalized images. A scan is then made of the stored personalized images for the data tags and the results of the scan are filtered and the results provided to the user for user verification of the integrity of the information in the personalized images. If the user determines that the information inputted from the database into the personalized images is not correct, provision is made for the user to input corrections at the user input interface. The personalized images are reconfigured with respect to the variable data, rescanned and presented to the user for verification. Upon user verification that the personalized images are acceptable, the personalized images are released to the print engine for execution of the print job.

### BRIEF DESCRIPTION OF THE DRAWINGS

The sole drawing is a block flow diagram of the method of the present disclosure.

### DETAILED DESCRIPTION

Referring to the drawing, a system for practicing the method of the present disclosure is indicated generally at 10; and, the system operates at step 20, through a user input interface, to provide for user entry of instructions and commands. The system proceeds from the interface with user input at step 20 to step 22 for the design of the image template; and, variable data is inputted from a database at step 24. The system then proceeds to emit personalized images in step 26 with the variable data entered in step 24 onto each personalized image. The system then proceeds to step 28 to store the personalized images emitted at step 26 and to have data tags for the variable information inserted at step 30 into the stored images of step 28.

The system then proceeds to step 32 and scans the stored personalized images for the data tags based upon selected scan criteria set by the user at step 34 and inputted to the scanning process at step 32.

The system then proceeds to filter the results of the scan at step 36 based upon user selected filter criteria set at step 38 and inputted to the process of step 36.

The system then proceeds to step 40 and inquires as to whether the scan results are acceptable; and, if the determination of step 40 is affirmative, the results are displayed to the user at the user interface as indicated by the return arrow to step 20. However, if the determination of step 40 is negative the results are displayed to the user at step 42; and, user input for corrections are entered at step 44 and these are inputted to step 26 for correcting the personalized images. When acceptable scan results are verified by the user by affirmative determination at step 40, the user may then input a command to release the personalized images for printing at step 46.

The present disclosure thus describes a method or a process for pre-proofing personalized images created by variable data inputs from a database and storing the personalized images. Data tags are entered in the information in the personalized images and the images scanned for data tags. The results of the scan are presented to the user for enabling correction inputs at the user interface prior to executing printing of the personalized images.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of prepress proofing a variable information digital printing job comprising:
(a) providing a database of record images;
(b) selecting according to a set of instructions certain record images from the database;
(c) entering user designated variable data into the selected record images;
(d) inserting data tags on the variable data entered into the selected record images;
(e) storing the tagged record images;
(f) scanning the images in the store for a specified tag and identifying those record images containing the specified tag;
(g) indicating the results of the scan to the riser; and,
(h) providing interface for user inputs to correct the stores images.

2. The method defined in claim 1, wherein the step of providing an interface includes providing a panel for tactile input.

3. The method defined in claim 2, wherein the step of providing a panel includes providing a touch screen.

4. The method defined in claim 1, wherein the step of indicating the results of the scan includes filtering.

5. The method defined in claim 4, wherein the step of filtering includes selecting filtering criterion from a user input at the interface.

6. The method defined in claim 1, wherein the step of inserting data tags includes inserting data tags according to predetermined criteria.

7. The method defined in claim 1, further comprising providing a print engine and releasing the stored images to the print engine and executing a print job.
